(19) United States
(12) Patent Application Publication
(10) Pub. No.: US 2011/0025449 A1
(43) Pub. Date: Feb. 3, 2011

(54) Bi-metal snap action disc

(76) Inventors: Stefan Grosskopf, Straubenhardt/Conweiler (DE); André Rudolph, Schorndorf (DE)

Correspondence Address: KLAUS J. BACH, 4407 TWIN OAKS DRIVE, MURRYSVILLE, PA, 15668, US

(21) Appl. No.: 12/804,854

(22) Filed: Jul. 30, 2010

(30) Foreign Application Priority Data
Aug. 1, 2009 (DE) 102009035829.3-34

(51) Int. Cl. H01H 37/54

(52) U.S. Cl. 337/365

(57) ABSTRACT

In a bi-metal snap-action disc with an arched main element whose arch projecting in one direction snaps over to an opposite direction when a certain temperature is reached, the main element is provided with a heating element formed by an electrically conductive strand disposed directly on the main element.

The invention resides in a bi-metal snap action disc with a curved main element whose curvature is changed, under the influence of temperature, in opposite directions. Furthermore, the invention relates to a switching element which includes a bi-metal snap-action disc with at least two switching contacts.

A bimetal snap-action disc is disclosed for example in EP 0813215 B1.

The known snap-action disc is installed in a temperature monitor so as to operate a contact structure. The contact structure is actuated when the set temperature point of the bimetal snap-action disc is reached, at which point the bi-metal snap-action disc snaps over from a convex to a concave form.

It is further known to use bi-metal snap-action discs as overcurrent release devices. That is, the bimetal snap-action disc is used for opening an electric circuit when the current in the circuit becomes excessively high. To this end, the electric current includes a resistance heater, which is generally arranged below the bimetal snap-action disc. When an excessively high current flows through the circuit, the resistance assumes a correspondingly high temperature so that the bimetal snap-action disc is heated and snaps over from its convex shape to its concave shape, that is, it is curved in the opposite direction. In this way, a contact member arranged normally at the center of the curved disc is moved so as to open an electric circuit.

A bimetal snap-action disc is to be understood to be a metal disc which consists of layers of different materials which is so punched as to have a surface curvature in different directions with a stable and a metastable state.

Although such over-current switches operate generally quite reliably, their design is relatively expensive. In addition, they react relatively slowly because of the indirect heating of the snap-action disc.

It is the object of the present invention to provide a bimetal snap-action disc and a switching element with substantially improved circuit monitoring and control properties.

### SUMMARY OF THE INVENTION

In a bi-metal snap-action disc with an arched or curved main element whose arch snaps over to an opposite direction when a certain temperature is reached, the main element is provided with a heating element formed by an electrically conductive strand disposed directly on the main element.

Since a heating element in the form of an electric conductor is disposed directly on the bimetal snap-action disc the bi-metal snap-action disc is no longer indirectly heated but is heated directly by the heating element. In this way, the reaction time of the bi-metal snap-action disc is substantially reduced. The reaction time of the bi-metal snap-action disc is also affected by a suitable selection of the materials of which the electric conductor consists. In addition, the bi-metal snap-action disc becomes less sensitive to external influences, which is very advantageous with respect to the reliability of a respective overcurrent controller. With the direct mechanical connection between the electric conductor and the main element of the bi-metal snap-action disc a compact device is formed.

It is advantageous if the electrical conductor is in the form of a conductor band which can easily be arranged on the main element of the bi-metal snap-action disc. The electric conductor may for example be punched out of a metal sheet and may be attached to the main element.

It is very advantageous if the electrical conductor is applied to the main element after the main element is already embossed that is when it is already curved. This is advantageous with respect to the snap-action behavior of the snap-action disc. In particular for example the snap-action point can then be set very precisely. The bi-metal snap-action disc may be stamped by means of a special punching procedure for example by a ring- or calotte stamping process or by single or multi-stamping steps so that well-defined snap-action temperatures T1/T2 are provided. The temperatures are the result of the punching procedures and the deformation and are specific for a respective application for which the device is to be used. The electric heating conductor is applied to the disc after its deformation by punching.

It is also advantageous if the electrical conductor is embedded in a lacquer layer disposed on the main element. Embedding, the conductor in a lacquer layer not only provides for a simple reliable connection of the electrical conductor with the main element but additionally the electrical conductor is electrically insulated on the main element. However, insulation can also be obtained by the application of an insulating foil.

It is pointed out that, between the electric conductor and the main element, an insulating plastic foil, that is a polyimide foil or an aluminum oxide foil may be provided, which, on one hand, is firmly connected to the main element and, on the other, to the heating element by means of a cement layer consisting of a Pyralux cement. Alternatively, the insulation layer may consist of Meycoat in connection with an acrylate cement or Dublocoll TC Al-foil. The connection of the insulating layer with the main element and the electrical conductor occurs in a special thermal process in such a way that for the establishment of the layer formation, the layers are durably joined under a pressure of about 2 tons to 20 tons and a temperature of 100° C. to 250° C.

As a result of the direct connection of the electrical conductor with the main element, there is a direct thermal coupling formed between the two elements. This provides for an optimal and homogeneous heat transfer from the electrical conductor to the main element so that with an increase in the current flow, a rapid reaction is obtained.

It is particularly advantageous if the electrical conductor extends over the area of the highest elevation of the main element and its resistance is the highest in the area of the highest elevation of the main element. In this way, the energy loss of the electrical conductor is greatest in the area of the highest elevation of the main element with the result that most heat is generated in the area of the highest elevation. This is very advantageous for the snap-action behavior of the main part.

The increased resistance of the electrical conductor in the area of the highest elevation of the main element can be achieved in a simple manner for example by making the cross-section of the electrical conductor smaller in the area of the highest elevation of the main element. In this way, the main element can be symmetrically heated in the area of the highest elevation which is also very advantageous for the switching function of the bi-metal snap action disc.

An embodiment of the invention has been found to be particularly advantageous wherein, in a top view, the main element has at least partially the shape of two circle segments which abut each other so that the chords of the circle segments form a virtual center line of the main element extending in the direction of the largest extension (length) of the main element. Such a shape, which is comparable to the shape of a bi-convex lens has the advantage of providing for a good snap-action behavior if mounted at one end. Since a switching contact disposed at the end opposite the mounting location travels during the snap action of the main element over a relatively large distance such a snap-action disc is well suitable for opening an electric circuit.

Advantageously, the main element is flattened at the ends of its center line whereby, in a top view, it has the form of a barrel body in side view. In this way, the main element has a relatively small size which however does not detrimentally affect the snap-action behavior of the main element.

A bi-metal snap-action disc which has a main element length from tip to tip which is 1.4 to 3 times the width of the main element in the direction transverse to the center line of the main element has been found to be particularly advantageous. In particular, a length of the main element of 2 to 2.75, preferably 2.5 times the width of the main element is preferred. If the main element is flattened at the ends of its center line, for the determination of the length of the main element, the length of the removed tips is theoretically added and the length of the main element is then formed by the distance between the two fictional tips of the main element.

Such an element has the important advantage that material tensions are being well distributed in the main element so that they have only little effect on the electrical conductor arranged on the main element.

In a further special embodiment of the invention, the main element is provided with locking elements which extend for example noticeably over the circumference of the shape described above. The locking elements extend preferably symmetrically to the centerline noticeably beyond the main element. With the locking elements, the main element, after a map action, can be prevented from a return snapping. To this end, the locking elements only need to be locked to corresponding counter elements after the snap action of the main element so that the snap position of the main element is fixed. Such a bi-metal snap action disc is very good for a so-called safety shut-off circuit, since the snap-action disc will not return automatically to its original position after cool-down of the main element.

In another embodiment of the invention, the switching element is arranged in a housing which consists of a material which is insulated at least at one side thereof such as a plastic-coated sheet metal. In this way, a complete insulation of the switching element from the ambient is achieved in a simple manner.

Preferably, the housing is formed by folding of a corresponding cutout part wherein the edges of the cutout part are interconnected for example by laser welding. Such a housing can be manufactured easily and inexpensively. In particular, the housing may be made watertight in this way in a simple manner.

Particular features and advantages of the present invention will become more readily apparent from the following description of a particular embodiment with reference to the accompanying drawings.

### BRIEF DESCRIPTION OF THE DRAWINGS

FIG. 1 shows a snap-action bi-metal disc according to the invention,

FIG. 2 is a top view of the snap-action disc shown in FIG. 1,

FIG. 3 is a side view of the snap-action disc shown in FIG. 1,

FIG. 4 is a sectional side view of a switching element according to the invention,

FIG. 5 is a cross-sectional view of the switching element taken along line A-A of FIG. 4,

FIG. 6 shows another embodiment of the bi-metal snap-action disc according to the invention,

FIG. 7 is a top view of the snap-action disc of FIG. 6;

FIG. 8 shows a second embodiment of a switching element in a sectional side view, and

FIG. 9 is a cross-sectional view of the switching element according to FIG. 8 taken along the line B-B.

### DESCRIPTION OF EXEMPLARY EMBODIMENTS

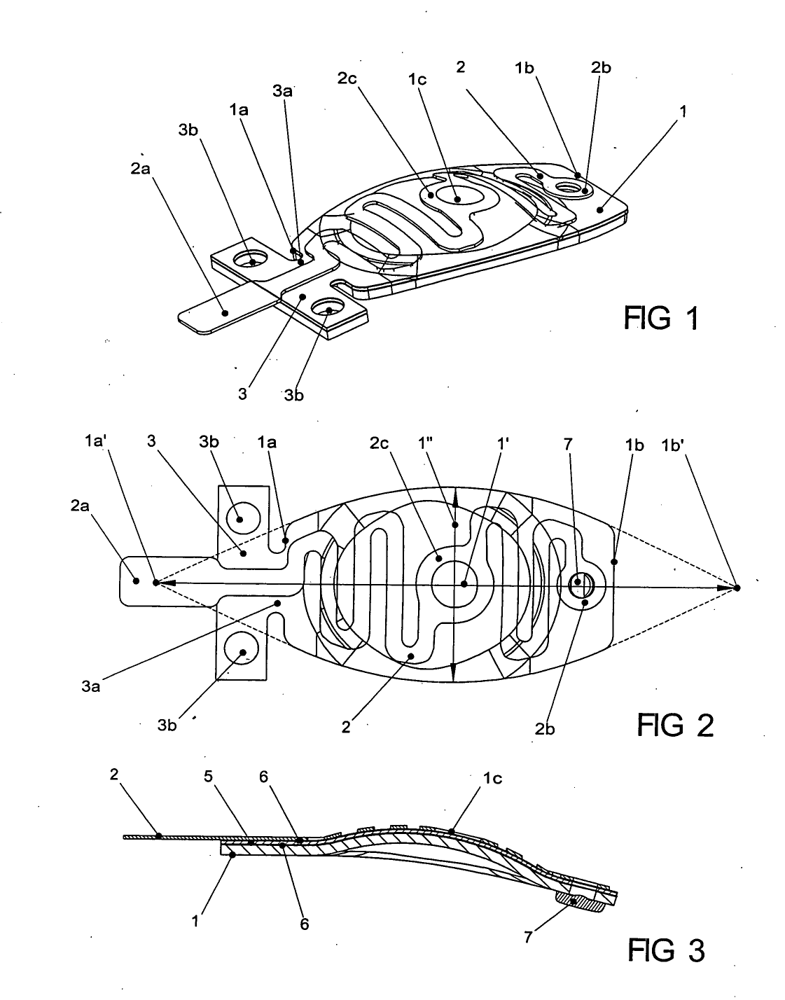

As shown in FIG. 1, the bi-metal snap-action disc comprises a main element 1 which, in a top view, has the shape of two circle segments which abut each other so that the chords of the circle segments form a virtual center line 1′ of the main element extending in the direction of the largest extension of the main element 1. The main element is in the form of a snap-action disc and has its highest elevation at the center point 1c. At one end 1a of the main element 1a side bar 3 is connected to the main element 1 by means of a web 3a. The side bar 3 includes two openings 3b for mounting the bi-metal snap-action disc.

On the main element 1, an electrical conductor 2 in the form of a flat strip extends in a meander course. The electrical conductor 2 includes an annular section 2c which extends around the highest elevation 1c of the main element. The cross-section of the electrical conductor 2 is reduced in the annular area 2c so that the resistance of the conductor 2 is the highest in that area.

At one end 2b of the electrical conductor 2, the electrical conductor 2 is connected to a switch contact 7 which is welded to the main element 1 and the one end 2b of the electrical conductor 2. The other end 2a of the electrical conductor 2, which has the shape of a side bar, forms the electrical connection of the switch contact 7.

As shown in FIG. 3, a polyimide foil 5 is arranged between the electrical conductor 2 and the main element 1 to which it is firmly connected by means of a pyralux cement 6.

The electrical conductor 2 is also connected to the polyimide foil 5 by means of a pyralux cement 6.

The electrical conductor 2 can be applied to the main element 1 in that the material strip out of which the main element is cut and the material strip out of which the conductor strip is cut are moved in an untarnished, clean condition through the same combination tool. In addition, an insulation foil provided at both sides with a cement layer is introduced into the combination tool. To the cement layers, in each case, a non-sticky separation foil is applied. The insulation foil is applied to the material strip out of which the main element 1 is cut, or respectively, applied to the main element 1. Before the application, however, the separating foil facing the main element 1 is removed from the respective cement layer of the isolation foil. During the application of the insulation foil to the main element, the second separation foil is removed from the insulation foil and then the conductor strip 2 is applied to the insulation foil. In a stamping station, the elements disposed on one another are joined to one another at a temperature of about 100 degrees Celsius to 250 degrees Celsius.

The conductor 2 may also be embedded in a lacquer layer arranged on the main element 1. To this end, the main element 1 is coated with lacquer in a proceeding process step. This coating serves exclusively as an electrical separation. A further lacquer layer which serves as a connecting cement layer is applied to this insulation layer in a wet state. Subsequently, the contour of the main element 1 is cut out of the strip material from which the main elements is then removed.

The conductor strip 2 is manufactured in a corresponding manner. That is, the strand material of the electrical conductor is also coated in a preceding process with an insulation lacquer. To the insulation lacquer layer, a connecting cement layer is applied in a wet state. Then the contour of the electrical conductor strip is cut out of the strand material.

In the tool, in which the cutting takes place, a module may be arranged which is thermally insulated from the rest of the tool. The module can be heated so that the strip of electrically conductive material can be applied to the main element 1 at a temperature of about 100 degrees Celsius to 250 degrees Celsius. The pressure depends on the surface area of the components to be compressed.

In the two methods described above a post heating and/or a UV treatment may be performed. This has been found to be advantageous for the solidity of the elements joined to one another.

It has been found that the main element has an optimal snap-action response if the width 1″ of the main element 1 is in a certain relationship to the length of the main element 1. For calculating the ratio in FIG. 2, the side edges of the main element 1 following a certain radius were tangentially extended to their points of intersection 1a′, 1b′. The extensions are shown in FIG. 2 by dashed lines. The points of intersection 1a′, 1b′ determine the length of the center line 1′ which is needed for determining the calculation ratio. The length of the centerline 1′ that is the theoretical value of the length of the main element 1 is 2.5 times the length of the center line 1′ of the main element 1 extending transverse to the center line 1, that is, the width 1″ of the main element 1.

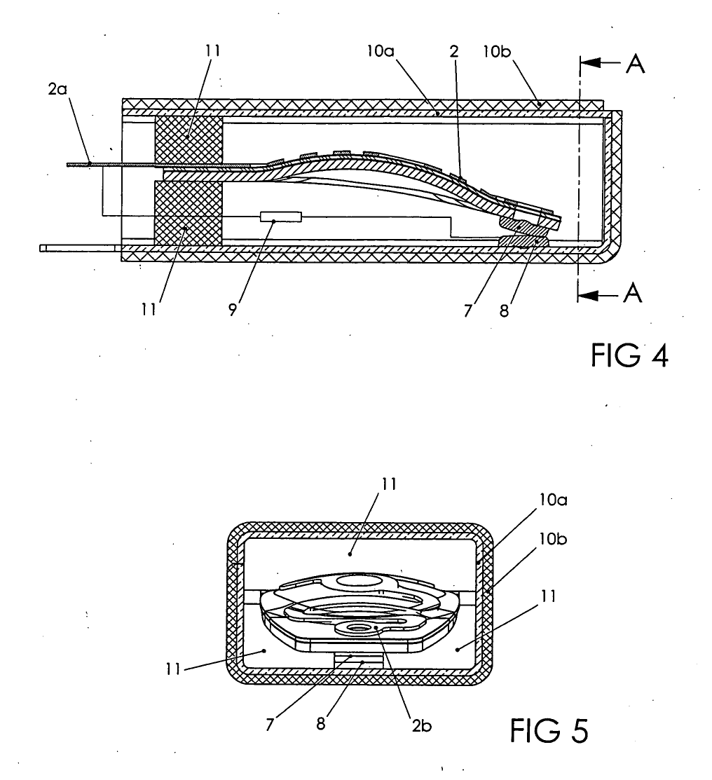

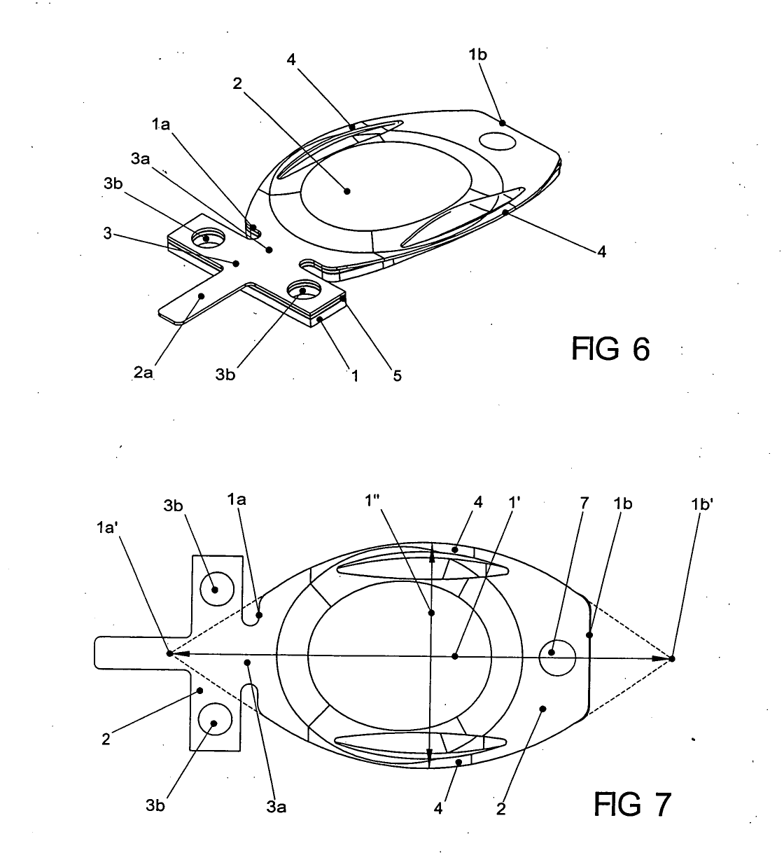

As apparent from the FIGS. 4 and 5, the bi-metal snap-action disc is clamped by way of a side bar 3 between elements 11 of a housing 10a, 10b, which elements consist of an electrically non-conductive plastic material. The housing 10a, 10b consists of sheet metal 10a which is coated at one side thereof with a plastic material 10b. In this way, the housing 10a, 10b is formed by folding of a cutout blank and subsequent laser welding.

The plastic elements 11 are applied before the folding of the cutout blank at the respective position. They may be applied as separate parts or the plastic may be applied by means of a spray-casting technique.

After the plastic elements 11 have been made the bi-metal snap-action disc is mounted on one of the elements by means of ultrasound welding, by clamping, stamping or pressing. By folding of the housing, the bi-metal snap-action disc is the enclosed and, since the two folds of the plastic elements are disposed opposite each other, after the folding the bi-metal snap-action disc is firmly engaged in the housing. As a result, the bi-metal disc is reliably fixed in its position.

Between the other end 2a of the electrical conductor 2 forming the switching contact 7 and a switching contact 8 attached to the housing a resistor 9 is arranged through which some current flow when the switching contact 7 arranged on the main element 1 is not in contact with the switching contact 8 attached to the housing. Then the resistor is heated whereby the main element 1 is heated so that it remains in the position in which the two switching contacts 7, 8 are not in contact with each other.

The embodiment as shown in FIG. 6 of a bi-metal snap action disc as shown in FIG. 6 corresponds essentially to the bi-metal snap action disc as shown in FIG. 1. It differs only in that it includes locking elements 4 which can be brought into engagement with projections 4a which are arranged in a housing of a switching element as shown in FIG. 9. The engagement elements 4 are arranged symmetrically with respect to center line 1′ of the main element 1 and project noticeably from the main element 1. They are formed from the edge areas of the main element 1 during the stamping operation. The engagement projections 4a are attached to the housing with the application of the plastic layer 10b of the housing and extend through an opening formed in the metal sheet 10a.

When the bi-metal snap action disc becomes so warm that it changes its position the locking elements 4 engage the engagement projections 4a. In this way, it is prevented that the bi-metal snap action disc returns to its original position when it cools down again. The bi-metal snap action disc consequently performs a one-time switch function like a fuse.

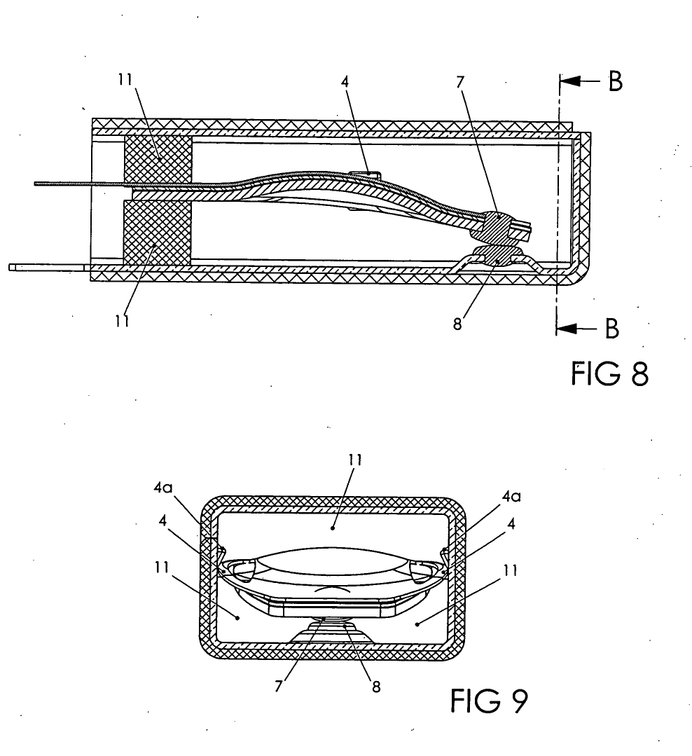

Since the bi-metal snap action disc does not switch repeatedly the switch contacts 7, 8 are riveted to the main element 1 or, respectively, the housing. This is shown in FIG. 8.

As shown in FIGS. 8 and 9, the switching contact 8 arranged on the housing is disposed on a pedestal. The pedestal is formed by stamping out of the sheet metal wall 10a of the housing. With the height of the pedestal, the switching movement of the switch formed by the arrangement can be adjusted.

Furthermore, the electrical conductor 2 extends almost over the whole surface of the main element 1 and is not meander-shaped as in the first embodiment. With the cutouts needed for the formation of the engagement elements 4, the cross-section of the main element and of the electrical conductor is reduced in the area of the engagement elements 4, that is, in the area of the highest elevation 1c of the main element 1 so that the resistance of the electrical conductor is highest in that area.

What is claimed is:

1. A bi-metal snap-action disc with an arched main element (1) whose arch extends in one direction but snaps into an opposite direction under the influence of a temperature change, said main element (1) being provided with an electrical conductor (2) forming a first heating element in direct contact with the main element (1).

2. The bi-metal snap-action disc according to claim 1, wherein the electrical conductor (2) is in the form of a conductor strip.

3. The bi-metal snap action disc according to claim 1, wherein the electrical conductor (2) is embedded in an insulating layer arranged on the main element (1).

4. The bi-metal snap action disc according to claim 1, wherein the electrical conductor (2) extends over the area of the arched highest elevation (1c) of the main element (1) and the resistance of the electrical conductor (2) is greatest in the area of the highest elevation (1c) of the main element (1).

5. The bi-metal snap action disc according to claim 1, wherein the electrical conductor (2) is applied to the main element (1) only after the arch of the main element (1) has been formed by stamping.

6. The bi-metal snap action disc according to claim 4, wherein the resistance of the electrical conductor (2) is increased by changing the cross-section of the conductor by one of stamping and laser ablation.

7. The bi-metal snap action disc according to claim 1, wherein the electrical conductor (2) is, ring-like shaped in the area of the highest elevation of the main element (1) and the center of the ring (2c) is arranged at the highest elevation (1c) of the main element (1).

8. The bi-metal snap action disc according to claim 1, wherein the main element (1) has, in a top view, the shape of two circle segments whose cords are disposed adjacent one another and extend in the direction of the largest extent (length) of the main element (1) and form a virtual center line (1′) of the main element (1).

9. The bi-metal snap action disc according to claim 8, wherein the main element (1) is flattened at the ends (1a, 1b) of its center line (1′) so that, in a top view, it has the shape of a barrel as seen from a side thereof.

10. The bi-metal snap action disc according to claim 8, wherein the length of the main element (1) from virtual tip (1a′) to virtual tip (1b′) has a length which is 1, 4-3, especially 2 to 2.75 and preferably 2.5 times the width of the main element (1) in a direction normal to the center line (1′) thereof.

11. The bi-metal snap action disc according to claim 1, wherein the main element (1) includes looking means (4).

12. A switching element including at least two switching contacts (7, 8) wherein one of the switching contacts (7) is arranged on the main element (1) of a bi-metal snap action disc as defined in claim 1.

13. A switching element according to claim 12, wherein the switching contact (7) arranged on the main element (1) is connected to one end (2b) of the electrical conductor (2) and the other end (2a) of the electrical conductor (2) forms a connector of the switching contact (7).

14. A switching element according to claim 13, wherein, between the ends (2a) of the electrical conductor (2) and the switch contact which is not arranged on the main element (1), an electrical resistor (9) is arranged which forms a second heating element.

15. A switching element according to claim 12, wherein the switching element is arranged in a housing (10a, 10b), which consists of a metal sheet (10a) coated with plastic material at least at one side thereof.

16. A switching element according to claim 15, wherein the housing (10a, 10b) is formed by folding of a corresponding cutout blank and the edges of the blank are joined by laser welding.
